(19) United States
(12) Patent Application Publication
(10) Pub. No.: US 2018/0373092 A1
(43) Pub. Date: Dec. 27, 2018

(54) MULTI-SIDE VIEWABLE STACKED DISPLAY

(71) Applicant: Intel Corporation, Santa Clara, CA (US)

(72) Inventors: John P. Eley, Portland, OR (US); Aaron J. Steyskal, Portland, OR (US); Nobuyuki Suzuki, Portland, OR (US)

(73) Assignee: Intel Corporation, Santa Clara, CA (US)

(21) Appl. No.: 15/630,477

(22) Filed: Jun. 22, 2017

(51) Int. Cl. G02F 1/1335; G09G 5/02; G02F 1/1347; G09G 3/36; H04N 5/57; H04N 9/12; H04N 9/31

(52) U.S. Cl. CPC G02F 1/133533; G09G 5/028; G02F 1/13473; H04N 9/3126; H04N 5/57; H04N 9/12; G09G 3/3607

(57) ABSTRACT

Methods of forming display structures, and structures formed thereby are described. Display structures formed may include a display device comprising an emissive layer that includes an array of pixels, wherein each of the individual pixels of the pixel array are capable of emitting light in at least two directions. A controllable opacity layer may be disposed on the emissive layer, wherein the controllable opacity layer is capable of at least partially blocking light emission from the array of pixels.

### BACKGROUND

Common computing systems using displays, such as mobile phones and laptops, for example, utilize displays/display screens that are viewable in one direction, i.e. from either a front side or a back side of such a display screen. In the case of a flat panel liquid crystal display (LED), a backlight may be employed wherein a bright light is passed through the LCD display structure to view images on the display screen.

### BRIEF DESCRIPTION OF THE DRAWINGS

While the specification concludes with claims particularly pointing out and distinctly claiming certain embodiments, the advantages of these embodiments can be more readily ascertained from the following description when read in conjunction with the accompanying drawings in which:

FIGS. 1a-1g represent cross-sectional views of display structures according to embodiments.

FIGS. 2a-2c represent cross sectional views of transparent opacity controlled structures included in embodiments.

FIGS. 3a-3c represent opacity controlled structures included in embodiments.

FIGS. 4a-4c represent configurations of user views according to embodiments.

FIGS. 5a-5b represent configurations of user views according to embodiments.

FIGS. 6a-6d represent configurations of user views according to embodiments.

FIGS. 7a-7e represent configurations of user views according to embodiments.

FIGS. 8a-8g represent configurations of user views according to embodiments.

FIG. 9 represents a method according to embodiments.

FIG. 10 represents a schematic of a computing device according to embodiments.

### DETAILED DESCRIPTION

In the following detailed description, reference is made to the accompanying drawings that show, by way of illustration, specific embodiments in which the methods and structures may be practiced. These embodiments are described in sufficient detail to enable those skilled in the art to practice the embodiments. It is to be understood that the various embodiments, although different, are not necessarily mutually exclusive. For example, a particular feature, structure, or characteristic described herein, in connection with one embodiment, may be implemented within other embodiments without departing from the spirit and scope of the embodiments. In addition, it is to be understood that the location or arrangement of individual elements within each disclosed embodiment may be modified without departing from the spirit and scope of the embodiments.

The following detailed description is, therefore, not to be taken in a limiting sense, and the scope of the embodiments is defined only by the appended claims, appropriately interpreted, along with the full range of equivalents to which the claims are entitled. In the drawings, like numerals may refer to the same or similar functionality throughout the several views. The terms “over”, “to”, “between” and “on” as used herein may refer to a relative position of one layer with respect to other layers. One layer “over” or “on” another layer or bonded “to” another layer may be directly in contact with the other layer or may have one or more intervening layers. One layer “between” layers may be directly in contact with the layers or may have one or more intervening layers. Layers and/or structures “adjacent” to one another may or may not have intervening structures/layers between them. A layer(s)/structure(s) that is/are directly on/directly in contact with another layer(s)/structure(s) may have no intervening layer(s)/structure(s) between them.

Embodiments of methods of forming display structures, such as multi directional viewable display structures, are described. Those methods/structures may include a display device comprising an emissive layer that includes an array of pixels, wherein each of the individual pixels of the pixel array are capable of emitting light in at least two directions. A controllable opacity layer may be disposed on the emissive layer, wherein the controllable opacity layer is capable of at least partially blocking light emission from the array of pixels. The embodiments herein enable the fabrication of a display which allows a viewer to see an image displayed on a display screen of a computing device from either a front side, a back side or a simultaneous viewing of both front and back sides of the display screen, wherein the viewing direction is controllable. The embodiments may utilize an emissive layer, such as an organic light emitting diode display (OLED) comprising dual transmission properties, such that a user may view an image from either direction of a display screen, for example. A controlled/controllable opacity layer, or layers, which may include liquid crystal (LC) layers, e-ink structures, shutters, or other types of materials which are capable of changing degrees of opacity, may be disposed on the emissive layer, in embodiments. The emissive layer may include an OLED, or may comprise other suitable emissive layer materials that are capable of transmitting images in multiple directions. Combining a light emissive layer with an opacity controllable layer enables the display structures included herein to be viewable in multiple directions controllably.

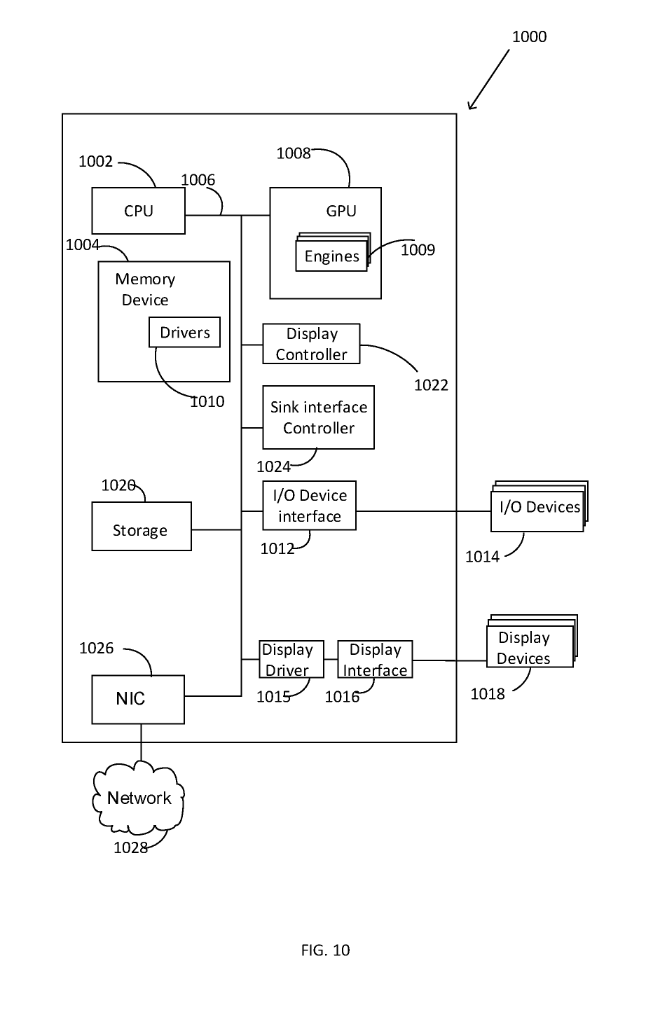

FIG. 10 is a block diagram illustrating an example computing device/system. The computing device 1000 may be, for example, a laptop computer, desktop computer, tablet computer, mobile device, or server, among others. The computing device 1000 may include a central processing unit (CPU) 1002 that is configured to execute stored instructions, as well as a memory device 1004 that stores instructions that are executable by the CPU 1002. The CPU 1002 may be coupled to the memory device 1004 by a bus 1006. Additionally, the CPU 1002 can be a single core processor, a multi-core processor, a computing cluster, or any number of other configurations. Furthermore, the computing device 100 may include more than one CPU 1002. The memory device 1004 can include random access memory (RAM), read only memory (ROM), flash memory, or any other suitable memory systems. For example, the memory device 1004 may include dynamic random access memory (DRAM).

The computing device 1000 may also include a graphics processing unit (GPU) 1008. As shown, the CPU 1002 may be coupled through the bus 1006 to the GPU 1008. In some cases, the GPU 1008 is embedded in the CPU 1002. In other cases, the GPU 1008 may be a discrete component relative to the CPU 1002. The GPU 1008 may include a cache, and can be configured to perform any number of graphics operations within the computing device 1000. For example, the GPU 1008 may be configured to render or manipulate graphics images, graphics frames, videos, or the like, to be displayed to a user of the computing device 1000. Displaying image data may be carried out by one or more engines 109 of the GPU 1008, a display driver 1015, a display interface 1016, and the like.

The memory device 1004 can include random access memory (RAM), read only memory (ROM), flash memory, or any other suitable memory systems. For example, the memory device 1004 may include dynamic random access memory (DRAM). The memory device 1004 may include device drivers 1010 that are configured to execute the instructions for device discovery. The device drivers 1010 may be software, an application program, application code, or the like.

The CPU 1002 may also be connected through the bus 1006 to an input/output (I/O) device interface 1012 configured to connect the computing device 1000 to one or more I/O devices 1014. The I/O devices 1014 may include, for example, a keyboard and a pointing device, wherein the pointing device may include a touchpad or a touchscreen, among others. The I/O devices 1014 may be built-in components of the computing device 1000, or may be devices that are externally connected to the computing device 1000. In some examples, the memory 1004 may be communicatively coupled to I/O devices 1014 through direct memory access (DMA).

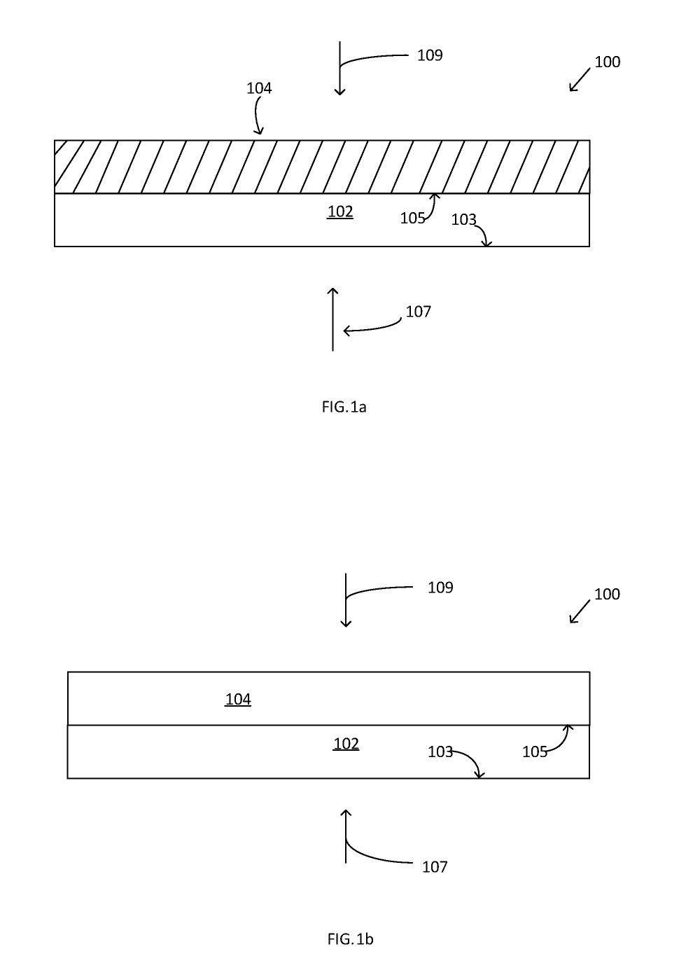

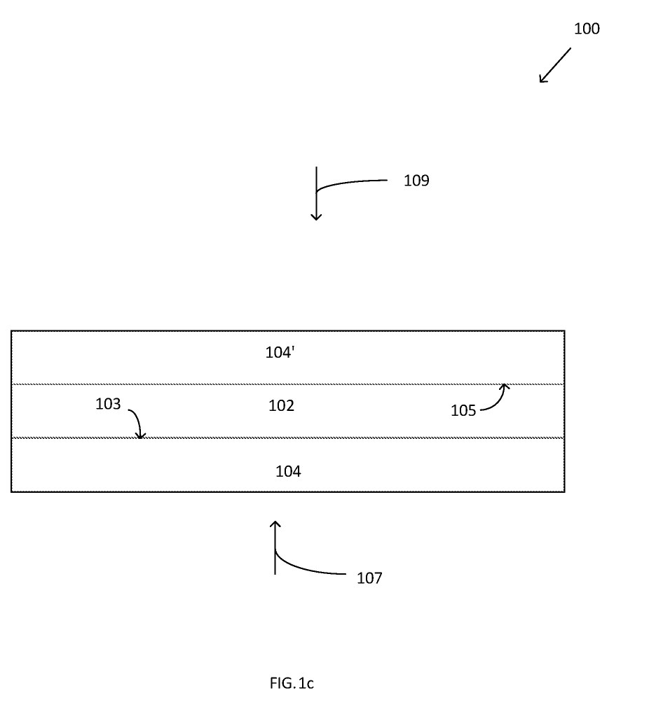

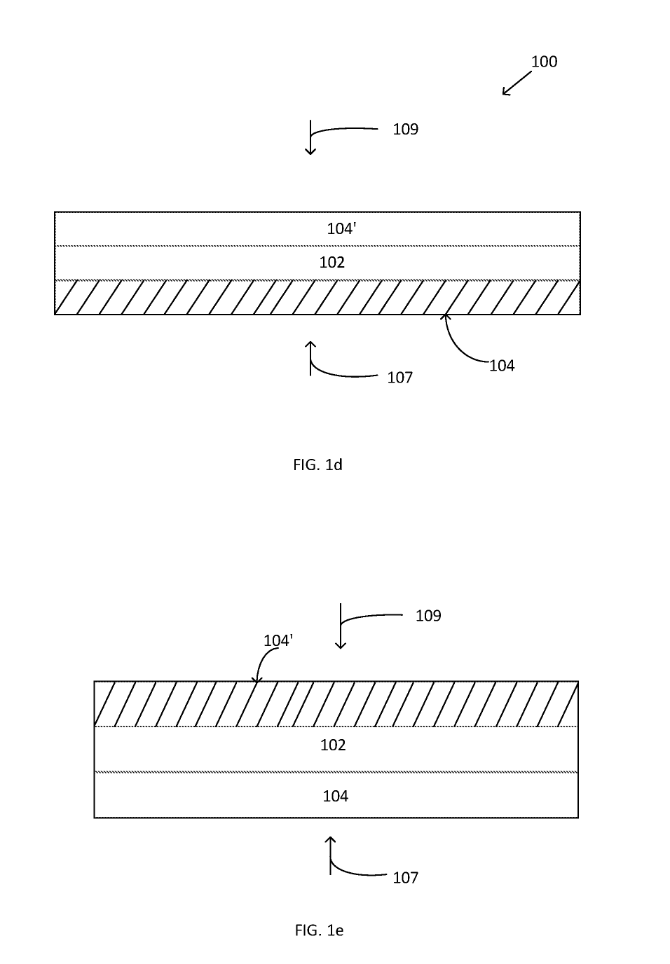

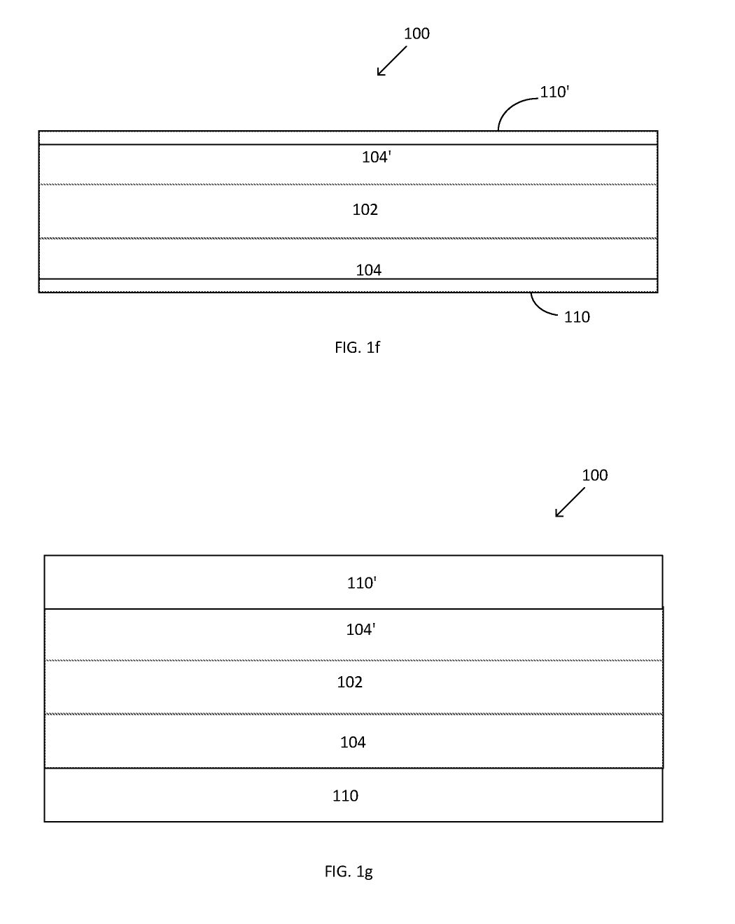

The CPU 1002 may also be linked through the bus 1006 to a display interface 1016 configured to connect the computing device 1000 to a display device 1018, wherein the display device 1018 may comprise one or more of the display structure embodiments included herein, such as portions of the display structures 100 of FIGS. 1a-1g, for example. The display device 1018 may include a display screen that may or may not be a built-in component of the computing device 1000. The display device 1018 may also include a computer monitor, television, or projector, among others, that is internal to or externally connected to the computing device 1000. In some examples, the display device 1018 includes a timing controller that can include an internal clock oscillator. The oscillator can be used to manage display device refresh with video data. In some examples, the display device 1018 can also include a sink interface controller that includes a FIFO to receive video data to be displayed. For example, the FIFO can be of any suitable size, such as anywhere from four kilobytes to ten megabytes in size or more.

The computing device also includes a storage device 1020. The storage device 1020 is a physical memory such as a hard drive, an optical drive, a thumbdrive, an array of drives, or any combinations thereof. The storage device 1020 may also include remote storage drives. The computing device 1000 may also include a network interface controller (NIC) 1026. The NIC 1026 may be configured to connect the computing device 1000 through the bus 1006 to a network 1028. The network 10028 may be a wide area network (WAN), local area network (LAN), or the Internet, among others. In some examples, the device may communicate with other devices through a wireless technology. For example, Bluetooth® or similar technology may be used to connect with other devices.

The computing device 100 may also include a display controller 1022. The display controller 1022 may be implemented as logic, at least partially comprising hardware logic. In other cases, the display controller 1022 may be implemented as a portion of software stored in the storage device 1004, as software or firmware instructions of the display driver 1015, the display interface 1016, the engines 1009 of the GPU 1008, the CPU 1002, any other suitable controller, or any combination thereof.

In yet other cases, the display controller 1022 may be implemented as electronic logic, at least partially comprising hardware logic, to be carried out by electronic circuitry, circuitry to be carried out by an integrated circuit, and the like. The display controller 1022 may be configured to operate independently, in parallel, distributed, or as a part of a broader process. In yet other cases, the display controller 1022 may be implemented as a combination of software, firmware, hardware logic, and the like. In some examples, the display controller 1022 may be used to receive a video transfer request packet and send an acknowledge response packet to a sink interface controller 1024.

In some examples, the sink interface controller 1024 may be included inside display device 1018. The display controller 1022 can send the video burst and receive a second acknowledge response packet from the sink interface controller 1024. The sink interface controller 1024 may be used to send a video transfer request packet to the display controller 1022. The sink interface module 1024 can receive an acknowledge response and video burst in response to the request packet. The sink interface controller 1024 can also send an acknowledge response to the video burst.

The block diagram of FIG. 10 is not intended to indicate that the computing device 1000 is to include all of the components shown in FIG. 10. Rather, the computing system 1000 can include fewer or additional components not illustrated in FIG. 10, such as sensors, power management integrated circuits, additional network interfaces, and the like. The computing device 1000 may include any number of additional components not shown in FIG. 10, depending on the details of the specific implementation. Furthermore, any of the functionalities of the CPU 1002 may be partially, or entirely, implemented in hardware and/or in a processor.

The various Figures included herein illustrate embodiments of fabricating and utilizing display structures that enables multi-side viewing by users, such as in handheld mobile devices, for example. The display structures of the embodiments may be incorporated into display screens/display devices of computing systems, such as the computing system depicted in FIG. 10. The display structures herein may comprise an emissive layer disposed on one or more controllable opacity layers that may be integrated into a display device, such as display device(s) 118 of FIG. 10.

In an embodiment, a display structure 100 is depicted comprising an emissive layer 102 that may be disposed on/attached to a controllable opacity layer 104 (FIG. 1a). In an embodiment, the controllable opacity layer 104 may comprise a separate layer, or may be included within a portion of the emissive layer 102. In an embodiment, the emissive layer 102 may comprise a layer that allows light to pass through in both directions (from a first side 103 and a second side 105) of the emissive layer 102. Light may also pass through side portions of the emissive layer 102, in some cases. The emissive layer 102 may comprise an array of pixels, that may transmit/display content, such as image/video images generated from a computing device that may be coupled with the display structure 100. The emissive layer 102 may comprise multiple sub layers, in some embodiments. The emissive layer 102 may comprise portions of an organic light emitting diode (OLED), portions of a quantum light emitting diode (QLED), quantum dot LED and/or a variant of a micro LED display, for example.

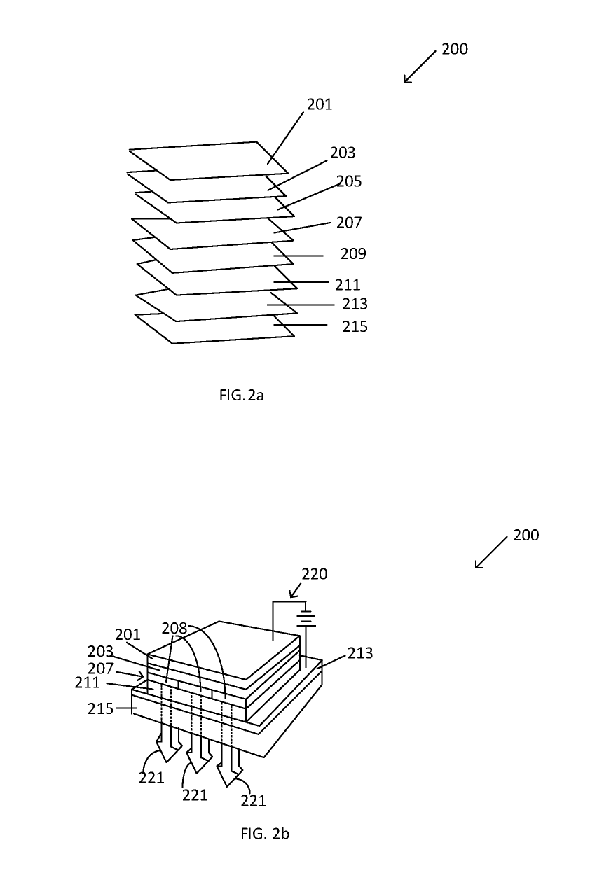

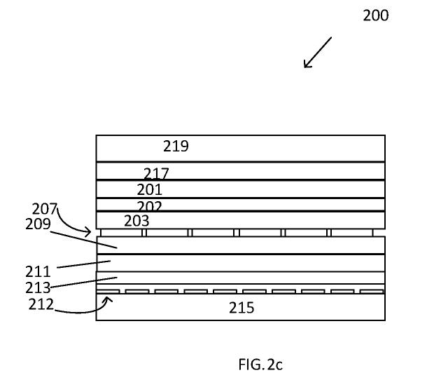

An example of an OLED structure that may be used as an emissive layer 102 is shown in FIGS. 2a-2c. In an embodiment, the OLED structure 200 may comprise an active matrix OLED (AMOLED) and/or a passive matrix OLED (PMOLED) (FIG. 2a, side perspective view). The OLED structure 200 may comprise a cathode 201, which may be a reflective or a transparent cathode, an electron transport layer (ETL) 203, a blocking layer (BL) 205, an emissive layer 207 (which may comprise a host and a phosphorescent light emitting diode emitter (PHOLED)), a hole transport layer (HTL) 209, a hole injection layer (HIL) 211, an anode 213, which may be reflective or transparent, and a substrate 215, which may be transparent, and may provide support for the OLED structure 200 (FIG. 2a). The OLED structure 200 may comprise a barrier material (not shown) which may provide a cover disposed on the OLED structure 200, and may serve to protect the OLED 200 from oxygen, moisture and physical harm, for example. The OLED structure 200 is capable of generating images/video (via an array of pixels located within/on the emissive layer 207) that may be displayed on a display screen, depending upon the requirements/inputs received from a computing device.

In FIG. 2b (side cross sectional view), a voltage 220 may be applied between the cathode 201 and the anode 213 of an OLED 200, wherein holes and electrons are injected from the HIL and the ETL layers 211, 203, respectively, into emitters 207, such as organic emitters, within the emissive layer 207. The organic emitters of the emissive layer 207 may comprise pixels 208, such as red, green and blue (RGB) pixels, for example. The OLED pixels 208 can scatter light in all directions, and are also known as a lambertain devices. The holes and electrons may recombine within the organic emitters/pixels 208 of the emissive layer 207, and upon recombining, energy pulses that may arise upon recombination create light waves 221, which may comprise RGB colors, for example.

FIG. 2c depicts a cross sectional view of an OLED structure 200 including a cover, such as a sealing cover glass 219, and a buffer layer 217 (including desiccant agent etc.), disposed on the cathode 201. An electron injection layer 202 is disposed on the ETL 203. An emissive layer 207 (including pixels) may be disposed on a HTL 209, and a HIL layer 211 may be disposed on the HTL 209. A thin film transistor (TFT) layer 212 may be disposed on the substrate 213, and may be located between the anode 213 and the substrate 215. In an embodiment, the anode 213 may comprise an indium titanium oxide (ITO) material. The TFT structures 212 may function to drive the OLED structure, wherein images displayed on a display screen depend upon current that each pixel of the emissive layer 207 may receive. The OLED structure 200 may comprise a solid-state semiconductor comprising carbon-based emitter material that emits light when electricity is applied. The pixel array of the emissive layer 207 may comprise an array of individual pixels which emit/scatter light in all directions.

Referring back to FIG. 1a, the controllable opacity layer 104 may be disposed on one side, such as on the second side 105, of the emissive layer 102, or may be disposed on a first side 103 in other embodiments. The controlled/controllable opacity layer 104 may comprise materials/structures that are optically transparent, wherein the opacity of the controllable opacity layer 104 may be controlled/varied according to the particular view direction/image requirements of a particular computing device, and/or the requirements of a particular viewer/user. The controllable opacity layer/structure 104 may comprise layers that can change opacity to selectively enable different viewing directions, and the opacity may be changed by electrical means, such as by the selection of appropriate current or voltage levels. The opacity changeable layer 104 may be made of a variety of structures/materials, such as liquid crystal (LC) materials, e-ink structures, shutter structures, electrochromic structures, and the like. The controllable opacity layer 104 may comprise a transparency that may be optimized, and may comprise non-binary levels (other than completely transparent or completely blocking) of opacity. The controllable opacity layer 104 may be designed to change its degree of opacity at a pixel level or at a larger block sized level, depending on the material selected and desired functionality, for example. The controllable opacity layer is capable of modulating a level of opacity in response to any suitable control mechanism, such as mechanical and/or electrical control mechanisms input received from a computing device.

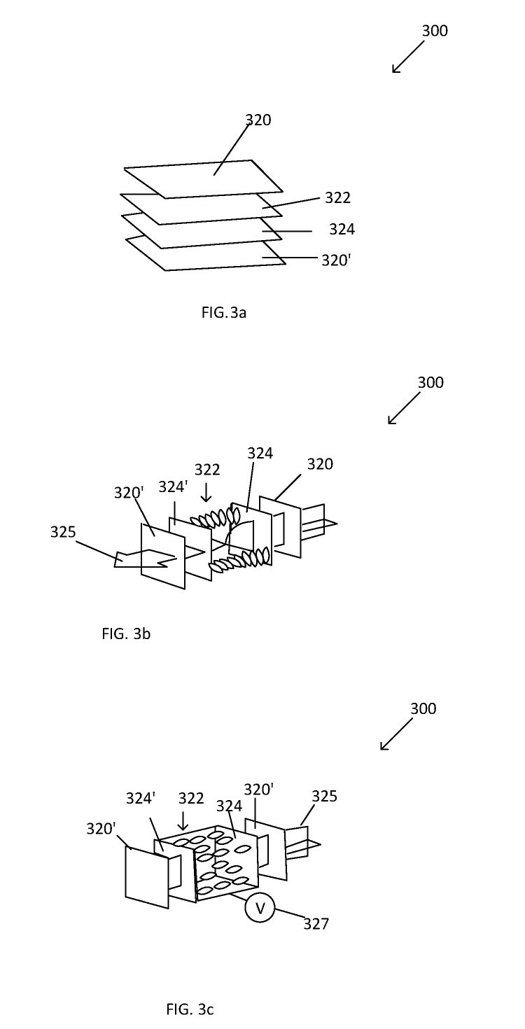

In an embodiment, the controllable opacity layer 104 may comprise portions of a liquid crystal display (LCD) structure. FIGS. 3a-3c depict examples of LCD structures that may be utilized as a controllable opacity layer 104 in the display structure 100 of FIG. 1a, for example. In FIG. 3a (side perspective view), a LCD structure 300 may comprise a first polarizer 320, a LC material 322, a substrate 324 (which may include a TFT layer and may also comprise an electrode), a second substrate 324′, which may comprise an electrode, and a second polarizer 320′. In an embodiment, the LCD structure 300 does not include a color filter or a back light unit. Light 325 may pass through the LCD structure 300, in an embodiment, wherein no voltage is applied between the electrodes 324, 324′ (FIG. 3b).

In FIG. 3c, a voltage 327 is applied between the electrodes 324, 324′, and the light 325 is not allowed to pass through the LCD structure 300. Thus, by controlling the LC material 322 by selecting an appropriate voltage 327 level, the LC material 322 may be used to allow or to block light from passing through the LCD structure 300. Opacity states of the LCD structure 300 (which may be incorporated into the display structure 100 of FIG. 1a, for example), may be controlled by a TFT layer that may be included in either of the electrodes 324, 324′. The exact structure and layout of the LCD structure 300 may be varied, depending upon the design requirements for a particular application, and the level of opacity control required. For example, individual pixels, sub-pixels or large regions may be controlled by the TFT circuitry.

In an embodiment, the controllable opacity layer 104 of FIG. 1a may be designed to change opacity at a pixel level, or in other embodiments may be configured to change opacity at a block sized level, depending upon material selection and desired functionality. For example, when an LC material of the controllable opacity layer 104 comprises a resolution of 640×480, and an OLED layer of the emissive layer 102 comprises a resolution of 4096×2160, blocks of the controllable opacity layer 104 may be controlled at a larger size than the high resolution OLED display pixels, thus simplifying LC layer electronics. In some embodiments, the controllable opacity layer 104 may be controlled to produce an in-between opacity level, such as a semi-transparent state, instead of binary states of transparent or non-transparent opacity levels. For example, the controllable opacity layer 104 may allow/select a hazy, low light to be displayed on viewable side of a display screen, or the controllable opacity layer 104 may allow/select a sepia or shadowy effect to be displayed on a display screen. Various effects may be employed by allowing/selecting a partial transmission of an image to be emitted from the controllable opacity layer 104. Such effects may be utilized in security applications, for example.

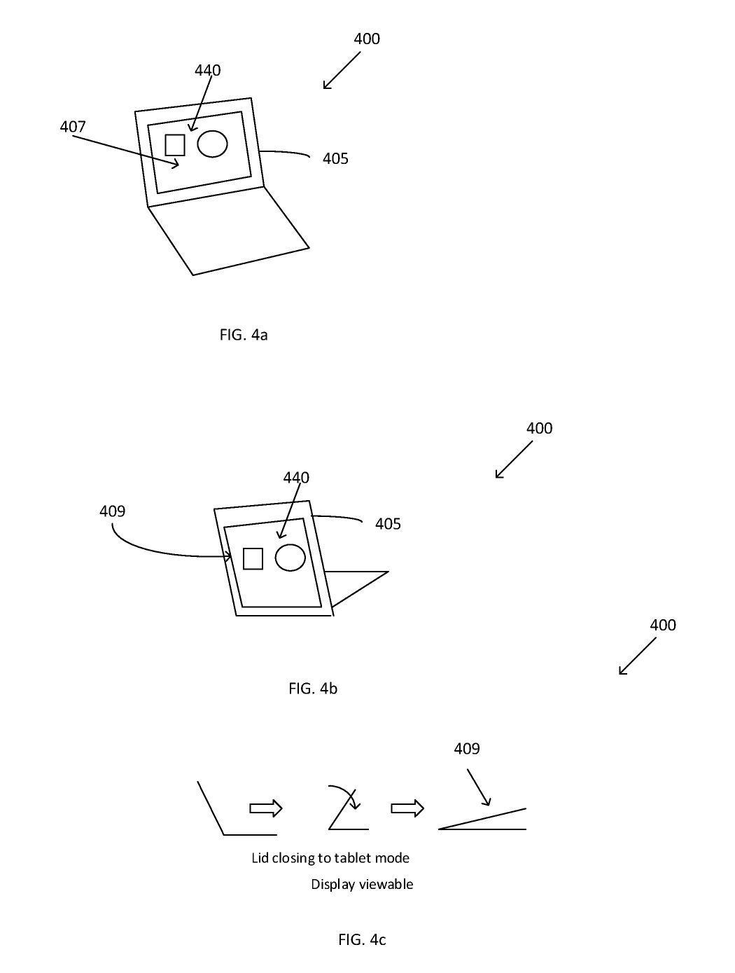

In FIG. 1a, a primary/first viewing direction 107 of the display structure 100 is shown, wherein the controllable opacity layer 104 is configured to block viewing of images generated from/through the display structure 100 from a backside (secondary) viewing direction 109. The primary and secondary viewing directions 107, 109 may correspond to a front side of a display screen, such as a front side of a laptop, and a backside of a laptop (or any computing device comprising a display), for example (see FIGS. 4a and 4c, showing a front side view 407 and a back side view 409, respectively). Primary and secondary views 107, 109 may correspond to other directions, such as a first and a second direction, in other embodiments. In FIG. 1b, the controllable opacity layer 104 may be configured to allow viewing of images from the backside (secondary) viewing direction 109 of the display structure 100, by allowing the transmission of light through both sides of the emissive layer 102.

In another embodiment, the emissive layer 102 may be disposed between a first controllable opacity layer 104 and a second controllable opacity layer 104′ (FIG. 1c). Simultaneous viewing from both the front side view 107 and the back side view 109 of a display device is enabled, wherein both the first and second controllable opacity layers 104, 104′ are selected to be transparent, via a control mechanism such as voltage, for example. In another embodiment, either the second viewing direction 109 (FIG. 1d) or the first viewing direction 107 (FIG. 1e) may be selected, by blocking the first controllable opacity layer 104 or the second controllable opacity layer 104′, respectively. In an embodiment, a cover lens may be included within at least a portion of one of the first controllable opacity layer 104, or within a portion of the second controllable opacity layer 104′. In another embodiment, a cover lens may be included in both the first and second controllable opacity layers 104, 104′.

In an embodiment, the display structure 100 may comprise a glass substrate or cover lens. The substrate/cover lens may also comprise a plastic material or any other material which serves to protect the display. The cover lens 110, 110′ may be incorporated into at least one of the controllable opacity layers 104, 104′, in an embodiment (FIG. 1f). The substrate/cover lens 110, 110′ may serve to protect the display 100 from scratches and/or other types of physical damage. In another embodiment, the display structure 100 may comprise at least one separate substrate/cover lens 110, 110′ disposed on at least one of the opacity controlled layers 104, 104′ (FIG. 1g). In other embodiments, at least one of the controllable opacity layers 104, 104′ may include touch and/or stylus layers. In another embodiment, touch and/or stylus layers may be disposed on surfaces of the cover lens/protective substrates 110, 110′, or in another embodiment, the touch and/or stylus layers/structures may be incorporated within the emissive layer 102) In other embodiments, at least one of the controllable opacity layers 104, 104′ may be integrated into the emissive layer 102.

In embodiments, (referring back to FIGS. 4a-4c), a user may view a display of images 440 from a first side 407 (which may comprise a front side of a display screen 405 of a computing device 400, such as but not limited to a laptop, for example) wherein a display structure (such as any of the display structures of FIGS. 1a-1g, for example) may be incorporated into the display screen/computing device, and may control the opacity of a controllable opacity layer such that the controllable opacity layer may block light from emitting out of the backside 409 of the display screen 405 of the computing device 400 (FIG. 4a) or may block light from emitting from the front side of the display screen (FIG. 4b). In an embodiment, the computing device 400 may be folded over/closed, and the display images 440 may be viewed on the back side 409 of the computing device display screen when closed (FIG. 4c). In another embodiment, controllable opacity layers may allow both front view 407 and back side view 409 of images 440 simultaneously. In an embodiment, the front and back sides may be opposite from each other.

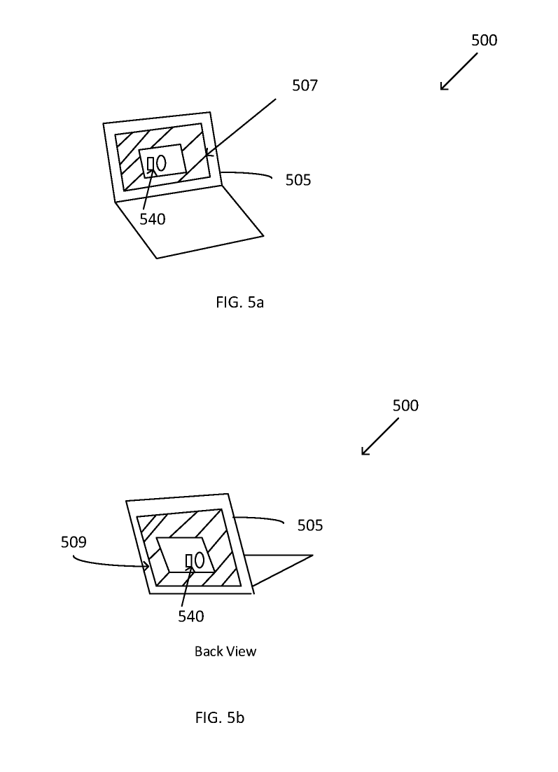

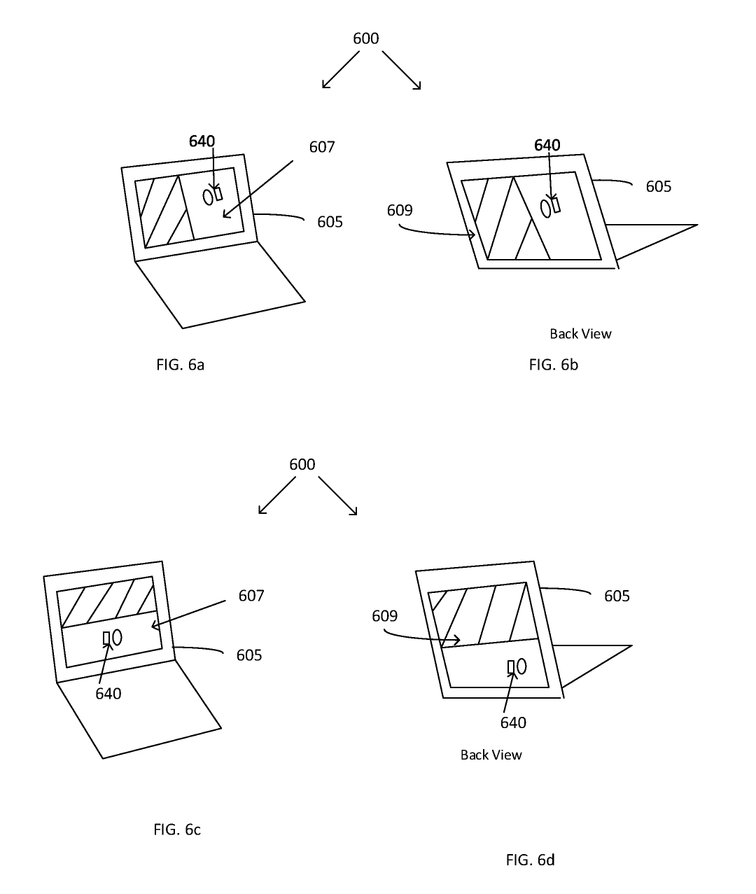

In another embodiment, the opacity controlled layer 104 may allow partial light to emit and be displayed from either the first or second sides 507, 509 of the display screen 505 (FIGS. 5a-5b). In an embodiment, the partial view of images 540 may be located in a central portion of the display device/screen of a computing device 500, or may be located in any other portions of a display screen/device. In an embodiment, the images may be viewed within multiple partial views that may be present within one display device/screen. In another embodiment, a partial view may be located in a vertical or a horizontal portion of the display screen 605 of a computing device 600, and images 640 may be displayed in either the front side (FIGS. 6a, 6c) or a back side FIGS. 6b, 6d) of a display screen 605 of a computing device 600. Thus, the display structures of FIGS. 1a-1g enable split screen displays in computing devices.

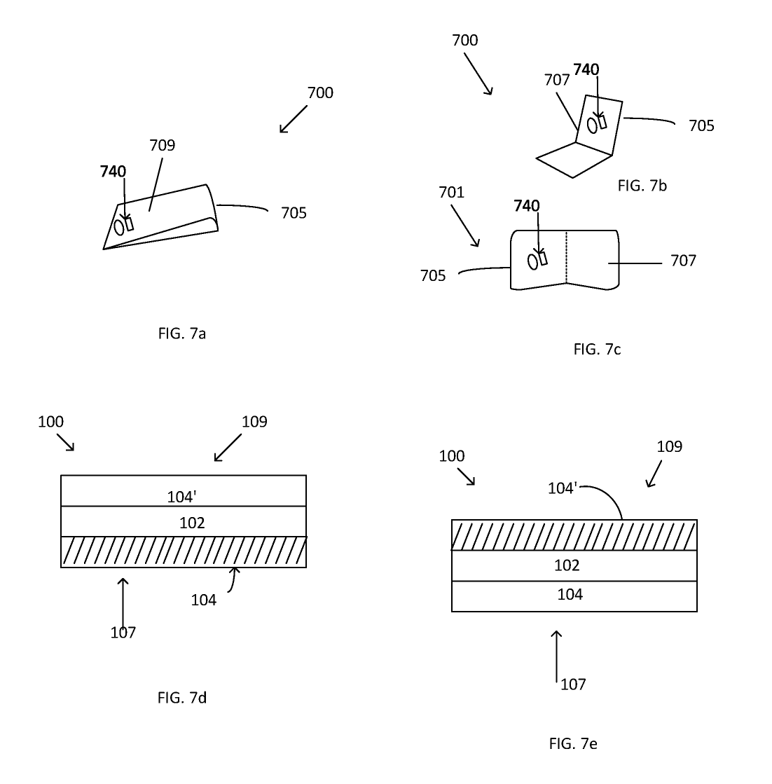

FIGS. 7a-7e depict embodiments that may be employed with a computing device 700. In FIG. 7a, a computing device 700 may display images on a back side 709. A display structure 100 is depicted in FIG. 7d that may be incorporated into the computing device 700, and may comprise a first controllable opacity layer 104 disposed on an emission layer 102. The display structure 100 may block emission of images/light from a front side 707 of the computing device 700. A second controllable opacity layer 104′ may allow light/images 740 to be viewed from the back side 709 of the computing device 700.

In FIG. 7b, a computing device 700, such as a laptop may display images 740 through a front side 707 of a display screen 705 of a computing device 700, and in FIG. 7c, a computing device 701, such as a mobile phone/hand held device, may display images through at least a portion of a front side 707 of a display screen 705 as well. Both of the computing devices 700, 701 may block light from a back side 709 of the computing device, in an embodiment. FIG. 7e depicts a display structure 100, that may be incorporated into a display screen of the computing devices 700, 701 that may comprise a first controllable opacity layer 104 that may allow emission of images/light 740 from the first side 707 of the display screens of the computing devices 700, 701, while a second controllable opacity layer 104′ may block light/images from being viewed from the back side 709 of the display screens of the computing devices 700, 701.

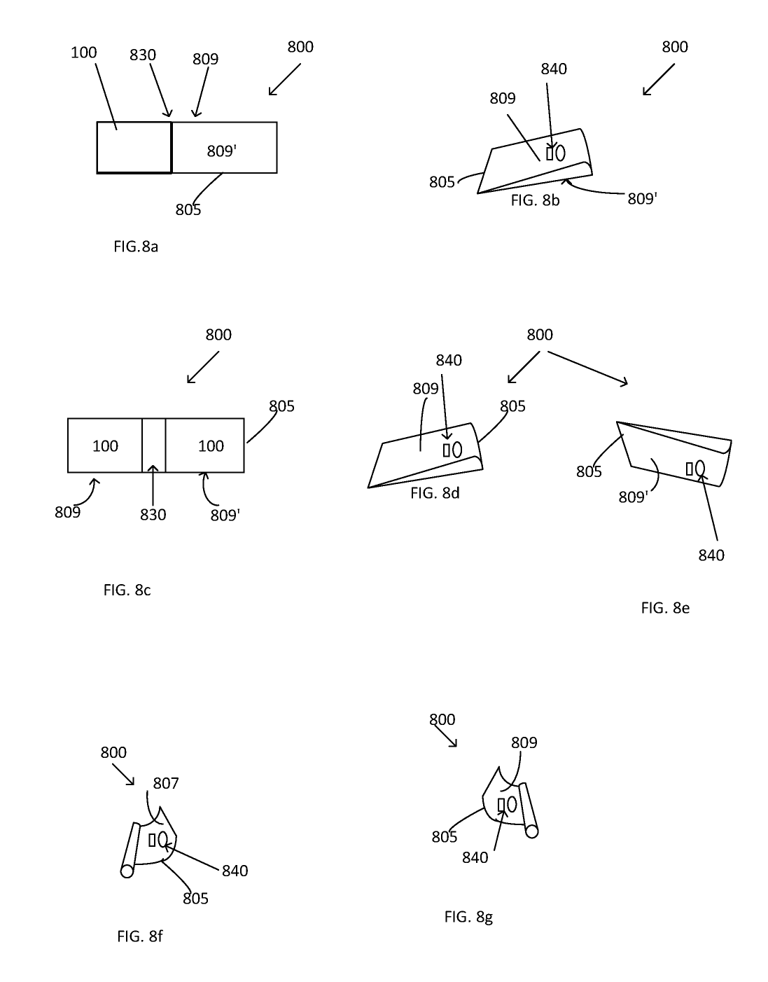

FIGS. 8a-8g depict further embodiments wherein the display structures 100 of FIGS. 1a-1g, for example, may be employed. In an embodiment, a back side 809 of a display screen 805 of a computing device 800 (FIG. 8a) comprising a hinge 830 may have a first portion of the backside 809 of the display incorporating a display structure 100 according to the embodiments herein, and a second portion of the back side 809′ that does not incorporate/does not comprise a display structure 100. Only one portion of the backside of the display screen 805, upon folding the computing device, comprises viewable images 840 (FIG. 8b). In another embodiment, a display screen 805 (FIG. 8c) of the computing device 800 may comprise two portions separated by a hinge mechanism 830, for example back portions 809, 809′ of the display screen 805 separated by hinge 830, that may both comprise display structures 100, such that images/video etc. 840 may be seen from the first portion and the second portion 809, 809′ (FIG. 8d, 8e) when the device 800 is closed/folded, regardless of the computing device 800 orientation. In other embodiments, the viewable portions may be employed with respect to the front side of the display device 800.

In another embodiment, display structures, such as the display structures of FIGS. 1a-1g, may be incorporated into a roll-able display device 800, such as is depicted in FIGS. 8f-8g. In an embodiment, when the roll-able display is unrolled in a first orientation 807 (FIG. 8f), sensors incorporated into the display 800 may detect the orientation/direction of the display screen 805, so that images 840 may be viewed on a first side 807 of the display screen 805. In another embodiment, sensors may detect that the roll-able display device 800 was oriented in a second direction 809 (FIG. 8g), so that images may be displayed on the second side 809 of the roll-able display device screen. In other embodiments, the display device may be configured to allow the user to choose a first, a second or simultaneous viewable sides to view images on the roll-able display screen sides.

The various embodiments of the display systems/structures describe herein a new approach to build display devices that comprise multi-viewable sides. When an OLED is used in a display structure, such as the display structure 100, the light is typically channeled toward the user to improve efficiency. The embodiments herein make use of the ability of such lambertain devices to emit light in all directions. The display structures herein may comprise various viewable embodiments when incorporated into computing systems, such as into a laptop, or mobile phone, for example. In an embodiment, a display is viewable when closed (i.e. in tablet view). The embodiments herein can be incorporated into foldable displays and devices. In typical folding displays the device folds inward, and cannot be seen without opening the device.

The embodiments herein enable an entire display or a portion of a display to be viewed from the outward side. This is very useful for notifications or other displayed content, for example. This functionality avoids adding a second display to allow for viewing while the device is closed, or having to open a device to retrieve information. The embodiments may be utilized in a notebook, two in one devices, tablet devices, point of sale device, and/or any foldable device. No backlight is required, so devices may be thinner. For example, a device may be fabricated that comprises about 0.79 mm in thickness or below.

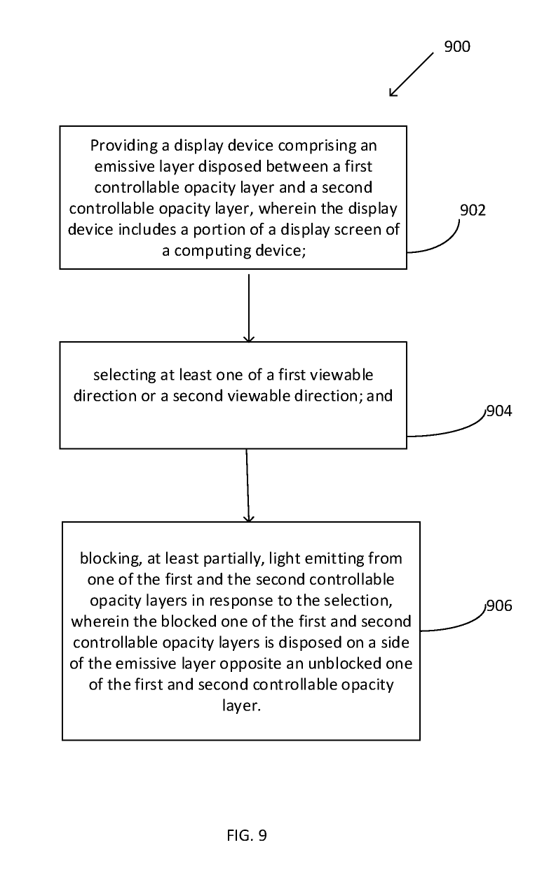

FIG. 9 depicts a method 900 of viewing images on a display screen, according to embodiments herein is described. At step 902, a display device comprising an emissive layer disposed between a first controllable opacity layer and a second controllable opacity layer is provided, wherein the display device includes a portion of a display screen of a computing device. At step 904, at least one of a first viewable direction or a second viewable direction is selected. For example, at least one of the opacity controlled layers may allow an image to be viewed from either a front side or a back side of the display screen, depending upon the desired selection. In other embodiments, both first and second viewable sides may be viewed simultaneously.

At step 906, light emitting from one of the first and the second controllable opacity layers is blocked, at least partially, in response to the selection, wherein the blocked one of the first and second controllable opacity layers is disposed on a side of the emissive layer opposite an unblocked one of the first and second controllable opacity layer. In an embodiment, at least one of the opacity controlled layers allows a non-binary opacity level to be emitted from either a front side or a back side of the display screen.

The various embodiments of the display structures included herein may be used for system on a chip (SOC) products, and may find application in such devices as smart phones, notebooks, tablets, wearable devices and other electronic mobile devices. In various implementations, the package structures may be included in a laptop, an ultrabook, a personal digital assistant (PDA), an ultra-mobile PC, a mobile phone, a desktop computer, a server, a printer, a scanner, a monitor, a set-top box, an entertainment control unit, a digital camera, a portable music player, or a digital video recorder. In further implementations, the display structures described herein may be included in any other types of electronic devices, such as those that process data.

### EXAMPLES

Example 1 is a display device comprising an emissive layer comprising an array of pixels, wherein each of the individual pixels of the pixel array are capable of emitting light in at least two directions; and a controllable opacity layer disposed on the emissive layer, wherein the controllable opacity layer is capable of at least partially blocking light emission from the array of pixels.

Example 2 includes the display device of example 1 wherein the display device comprises a first viewing side and a second viewing side.

Example 3 includes the display device of example 1 wherein the emissive layer comprises one of an organic light emitting diode (OLED) structure, a quantum dot LED structure, or a micro LED structure.

Example 4 includes the display device of example 1 wherein the controllable opacity layer comprises at least one of a liquid crystal material, an e-ink structure, an electrochromic structure, or a shutter structure.

Example 5 includes the display device of example 1 wherein a second controlled opacity layer is disposed on a second side of the emissive layer.

Example 6 includes the display device of example 5 wherein the display device is electrically and physically coupled with a computing device, and wherein images generated by the computing device are capable of being viewed from at least one of the first viewing side or the second viewing side of the display device.

Example 7 includes the display device of example 1 wherein the controllable opacity layer comprises an integrated touch or stylus function.

Example 8 includes the display device of claim 6 wherein the controllable opacity layer is capable of modulating a level of opacity in response to electrical signals received from the computing device.

Example 9 is a display structure comprising: an emissive layer comprising an array of pixels, wherein the pixel array is capable of emitting light in at least two directions; a first controllable opacity layer disposed on a first side of the emissive layer, wherein the first controllable opacity layer is capable of at least partially blocking an emission of light from the array of pixels; and a second controlled opacity layer on a second side of the emissive layer, wherein the second controllable opacity layer is capable of at least partially blocking an emission of light from the array of pixels.

Example 10 includes the display structure of example 9 wherein the display device comprises one of a foldable display device or a roll-able display device.

Example 11 includes the display structure of example 9 wherein the controllable opacity layer is optically transparent and comprises a controllable opacity level.

Example 12 includes the display structure of example 9 wherein the display structure is included in a display screen of a computing device, and wherein images generated by the computing device are capable of being viewed from a first side and a second side the display screen, wherein the first and second side are opposite each other.

Example 13 includes the display structure of example 9 wherein the controllable opacity layer is capable of changing opacity in a block of pixels of the array or by individual pixels.

Example 14 includes the display structure of example 9 wherein the opacity controllable structure is capable of changing from a transparent level to non-transparent level in response to electrical signals received by a computing device coupled to the display structure.

Example 15 includes the display structure of example 14 wherein images generated by the computing device are viewable from a first side of a display screen of the computing device and from a second side of the display screen of the computing device

Example 16 includes the display structure of example 15, wherein the computing device comprises a foldable laptop computer, and wherein the second side comprises a back side of the foldable laptop computer that is capable of being viewed in a closed position of the foldable laptop.

Example 17 is a system comprising: a processor for processing data; a memory for storage of data; a display device including: an emissive layer comprising an array of pixels, wherein the array of pixels is capable of emitting light in at least two directions; a first controllable opacity layer disposed on a first side of the emissive layer, wherein the first controllable opacity layer is capable of blocking, at least partially, light emission from the array of pixels; and a second controllable opacity layer disposed on a second side of the emissive layer, wherein the second controllable opacity layer is capable of blocking, at least partially, light emission from the array of pixels.

Example 18 includes the system of example 17 wherein the first controllable opacity layer is capable of blocking the viewing of images generated by the system from one of a first side of a display screen of the display device or a second side of the display screen of the display device.

Example 19 includes the system of example 18 wherein the second controllable opacity layer is capable of blocking viewing from one of a first side of the display screen or a second side of the display screen.

Example 20 includes the system of example 17 wherein the system comprises one of a laptop, a notebook, a two in one device, a mobile device, a foldable device or a roll-able display screen device.

Example 21 includes the system of example 17 wherein the display device comprises a display screen, wherein the display device is configured to allow images to be displayed in a first portion or in multiple portions of the display screen, and wherein at least a portion of the display screen is configured to block the images from the display screen.

Example 22 includes the system of example 21 further comprising wherein the first or multiple portions configured to display images comprise a split screen in either a horizontal or a vertical portion of the display screen.

Example 23 includes the system of example 21 wherein the first or multiple portions configured to display images is located in a central portion of the display screen.

Example 24 includes the system of example 17 wherein the emissive layer comprises one of an organic light emitting diode (OLED) structure, a quantum dot LED structure, or a micro LED structure.

Example 25 includes the system of claim 17 wherein the controllable opacity layer comprises at least one of a liquid crystal material, an e-ink structure, an electrochromic structure, or a shutter structure.

Example 26 is a method of displaying images on a display screen, comprising: providing a display device comprising an emissive layer disposed between a first controllable opacity layer and a second controllable opacity layer, wherein the display device includes a portion of a display screen of a computing device; selecting at least one of a first viewable direction or a second viewable direction; and blocking, at least partially, light emitting from one of the first and the second controllable opacity layers in response to the selection, wherein the blocked one of the first and second controllable opacity layers is disposed on a side of the emissive layer opposite an unblocked one of the first and second controllable opacity layer.

Example 27 includes the method of example 26 wherein the first and second controllable opacity layers comprise at least one of a liquid crystal material, an e-ink structure, an electrochromic structure, or a shutter structure.

Example 28 includes the method of example 26 wherein the emissive layer comprises one of an organic light emitting diode (OLED) structure, a quantum dot LED structure, or a micro LED structure.

Example 29 is at least one computer readable medium for selecting viewable directions of a display screen of a computing device having instructions stored therein that, in response to being executed on a computing device, cause the computing device to: select, via a processor, at least one of a first viewable direction or a second viewable direction of a display structure of example 26 and blocking, at least partially, light emitting from one of a first and the second controllable opacity layers in response to the selection, wherein the blocked one of the first and second controllable opacity layers is disposed on a side of the emissive layer opposite an unblocked one of the first and second controllable opacity layer.

Although the foregoing description has specified certain steps and materials that may be used in the methods of the embodiments, those skilled in the art will appreciate that many modifications and substitutions may be made. Accordingly, it is intended that all such modifications, alterations, substitutions and additions be considered to fall within the spirit and scope of the embodiments as defined by the appended claims. In addition, the Figures provided herein illustrate only portions of exemplary microelectronic devices and associated package structures that pertain to the practice of the embodiments. Thus the embodiments are not limited to the structures described herein.

What is claimed is:

1. A display device comprising:
an emissive layer comprising an array of pixels, wherein each of the individual pixels of the pixel array are capable of emitting light in at least two directions; and
a controllable opacity layer disposed on the emissive layer, wherein the controllable opacity layer is capable of at least partially blocking light emission from the array of pixels.

2. The display device of claim 1 wherein the display device comprises a first viewing side and a second viewing side.

3. The display device of claim 1 wherein the emissive layer comprises one of an organic light emitting diode (OLED) structure, a quantum dot LED structure, or a micro LED structure.

4. The display device of claim 1 wherein the controllable opacity layer comprises at least one of a liquid crystal material, an e-ink structure, an electrochromic structure, or a shutter structure.

5. The display device of claim 1 wherein a second controlled opacity layer is disposed on a second side of the emissive layer.

6. The display device of claim 5 wherein the display device is electrically and physically coupled with a computing device, and wherein images generated by the computing device are capable of being viewed from at least one of the first viewing side or the second viewing side of the display device.

7. The display device of claim 1 wherein at least one of the emissive layer or the controllable opacity layer comprises an integrated touch or stylus function.

8. The display device of claim 6 wherein the controllable opacity layer is capable of modulating a level of opacity in response to a control mechanism electrical signals received from the computing device.

9. A display structure comprising:
an emissive layer comprising an array of pixels, wherein the pixel array is capable of emitting light in at least two directions;
a first controllable opacity layer disposed on a first side of the emissive layer, wherein the first controllable opacity layer is capable of at least partially blocking an emission of light from the array of pixels; and
a second controlled opacity layer on a second side of the emissive layer, wherein the second controllable opacity layer is capable of at least partially blocking an emission of light from the array of pixels.

10. The display structure of claim 9 wherein the display device comprises one of a foldable display device or a roll-able display device.

11. The display structure of claim 9 wherein the controllable opacity layer is optically transparent and comprises a controllable opacity level.

12. The display structure of claim 9 wherein the display structure is included in a display screen of a computing device, and wherein images generated by the computing device are capable of being viewed from a first side and a second side the display screen, wherein the first and second side are opposite each other.

13. The display structure of claim 9 wherein the controllable opacity layer is capable of changing opacity in a block of pixels of the array or by individual pixels.

14. The display structure of claim 9 wherein the opacity controllable structure is capable of changing from a transparent level to non-transparent level in response to electrical signals received by a computing device coupled to the display structure.

15. The display structure of claim 14 wherein images generated by the computing device are viewable from a first side of a display screen of the computing device and from a second side of the display screen of the computing device

16. The display structure of claim 15, wherein the computing device comprises a foldable mobile device, and wherein the second side comprises a back side of the foldable mobile device that is capable of being viewed in a closed position of the foldable mobile device.

17. A system comprising:
a processor for processing data;
a memory for storage of data;
a display device including:
an emissive layer comprising an array of pixels, wherein the array of pixels is capable of emitting light in at least two directions;
a first controllable opacity layer disposed on a first side of the emissive layer, wherein the first controllable opacity layer is capable of blocking, at least partially, light emission from the array of pixels; and
a second controllable opacity layer disposed on a second side of the emissive layer, wherein the second controllable opacity layer is capable of blocking, at least partially, light emission from the array of pixels.

18. The system of claim 17 wherein the first controllable opacity layer is capable of blocking the viewing of images generated by the system from one of a first side of a display screen of the display device or a second side of the display screen of the display device.

19. The system of claim 18 wherein the second controllable opacity layer is capable of blocking viewing from one of a first side of the display screen or a second side of the display screen.

20. The system of claim 17 wherein the system comprises one of a laptop, a notebook, a two in one device, a mobile device, a foldable device or a roll-able display screen device.

21. The system of claim 17 wherein the display device comprises a display screen, wherein the display device is configured to allow images to be displayed in a first portion or in multiple portions of the display screen, and wherein at least a portion of the display screen is configured to block the images from the display screen.

22. The system of claim 21 further comprising wherein the first or multiple portions configured to display the images comprises a split screen in either a horizontal or a vertical portion of the display screen.

23. The system of claim 21 wherein the first or multiple portions configured to display the images is located in a central portion of the display screen.

24. The system of claim 17 wherein the emissive layer comprises one of an organic light emitting diode (OLED) structure, a quantum dot LED structure, or a micro LED structure.

25. The system of claim 17 wherein the controllable opacity layer comprises at least one of a liquid crystal material, an e-ink structure, an electrochromic structure, or a shutter structure.
